(19) United States
(12) Patent Application Publication
(10) Pub. No.: US 2011/0161320 A1
(43) Pub. Date: Jun. 30, 2011

(54) METHODS, APPARATUSES, AND COMPUTER PROGRAM PRODUCTS FOR GEOCODING DATA

(75) Inventors: Stuart Drew Golden, Alpharetta, GA (US); Holly T. Golden, Alpharetta, GA (US); Natalie R. Lawrence, Chamblee, GA (US)

(73) Assignee: McKesson Financial Holdings Limited, Hamilton (BM)

(21) Appl. No.: 12/649,136

(22) Filed: Dec. 29, 2009

(51) Int. Cl. G06F 17/30

(52) U.S. Cl. 707/736; 707/E17.018

(57) ABSTRACT

Methods, apparatuses, and computer program products are provided for geocoding data for use by a mapping utility. A method may include accessing a data record from a data set. The data record may include proprietary data and address data associated with the proprietary data. The method may additionally include formatting a request for geocoding information corresponding to the address data. The request may include the address data, but not the proprietary data. The method may also include directing transmission of the request to a geocoding service. The method may further include receiving geocoding information corresponding to the address data in response to the request. The method may additionally include generating a geocoded data record including the geocoding information and at least a portion of the proprietary data. The method may also include adding the geocoded data record to a file formatted to be compatible with the mapping utility.

### TECHNOLOGICAL FIELD

Embodiments of the present invention relate generally to data presentation and, more particularly, relate to methods, apparatuses, and computer program products for geocoding data for use by a mapping utility.

### BACKGROUND

Data having an associated location is often electronically maintained in the course of business. Such data may be maintained in an electronic data set comprising a database, spreadsheet, or the like. This data may include, for example, sales data, customer data, and/or the like as well as a location(s) associated therewith. Although arrangement of data in an electronic data set may provide an efficient way to view sales numbers, customer account information, or the like, viewing data in an electronic data set may not provide a meaningful way to analyze the data with respect to the associated location(s).

Mapping utilities, such as Google Earth, Google Maps, and the like provide for mapping geocoded data. In this regard, mapping utilities may be configured to accept a particularly formatted file including geocoded data comprising data and associated geocoding information (e.g., longitude and latitude coordinates) and render representation(s) of the geocoded data on a map such that the spatial arrangement of the data may be viewed.

### BRIEF SUMMARY OF SOME EXAMPLES OF THE INVENTION

Systems, methods, apparatuses, and computer program products are herein provided for geocoding data. The systems, methods, apparatuses, and computer program products provided in accordance with embodiments of the invention may provide several advantages to computing devices and computing device users. Embodiments of the invention provide for pre-geocoding of data. In this regard, embodiments of the invention provide for the generation of a file formatted for compatibility with a mapping utility that comprises one or more geocoded data records. Embodiments of the invention may provide for generation of such a file in advance of a request to render data records on a map using a mapping utility such that the data records are pre-geocoded so that data records do not have to be geocoded by the mapping utility during rendering of the map. As geocoding a data record may be a relatively time consuming process, pre-geocoding data records in accordance with embodiments of the invention may result in less user wait time for a map to be rendered and reduce the processing burden on mapping utilities. Embodiments of the invention additionally protect the confidentiality of proprietary data that may be included in a data record to be geocoded. In this regard, embodiments of the invention extract only the address data needed to obtain geocoding information from a data record and send the extracted address data to a geocoding service in a request for geocoding information corresponding to the extracted address data rather than sending the entire data record to the geocoding service. Accordingly, the proprietary information is not exposed to third parties through provision to the geocoding service.

In a first example embodiment, a method for geocoding data for use by a mapping utility is provided. The method of this embodiment comprises accessing a data record from a data set. The data record of this embodiment comprises proprietary data and address data associated with the proprietary data. The method of this embodiment further comprises extracting the address data from the data record. The method of this embodiment additionally comprises formatting a request for geocoding information corresponding to the address data. The request of this embodiment comprises the extracted address data, but not the proprietary data. The method of this embodiment also comprises directing transmission of the request to a geocoding service. The method of this embodiment further comprises receiving geocoding information corresponding to the address data in response to the request. The method of this embodiment additionally comprises generating a geocoded data record comprising the geocoding information and at least a portion of the proprietary data. The method of this embodiment also comprises adding the geocoded data record to a file formatted to be compatible with the mapping utility.

In another example embodiment, an apparatus for geocoding data for use by a mapping utility is provided. The apparatus of this embodiment comprises a processor configured to cause the apparatus to access a data record from a data set. The data record of this embodiment comprises proprietary data and address data associated with the proprietary data. The processor of this embodiment is further configured to cause the apparatus to extract the address data from the data record. The processor of this embodiment is additionally configured to cause the apparatus to format a request for geocoding information corresponding to the address data. The request of this embodiment comprises the extracted address data, but not the proprietary data. The processor of this embodiment is also configured to cause the apparatus to direct transmission of the request to a geocoding service. The processor of this embodiment is further configured to cause the apparatus to receive geocoding information corresponding to the address data in response to the request. The processor of this embodiment is additionally configured to cause the apparatus to generate a geocoded data record comprising the geocoding information and at least a portion of the proprietary data. The processor of this embodiment is also configured to cause the apparatus to add the geocoded data record to a file formatted to be compatible with the mapping utility.

In another example embodiment, a computer program product for geocoding data for use by a mapping utility is provided. The computer program product of this embodiment includes at least one computer-readable storage medium having computer-readable program instructions stored therein. The program instructions of this embodiment comprise program instructions configured to access a data record from a data set. The data record of this embodiment comprises proprietary data and address data associated with the proprietary data. The program instructions of this embodiment further comprise program instructions configured to extract the address data from the data record. The program instructions of this embodiment additionally comprise program instructions configured to format a request for geocoding information corresponding to the address data. The request of this embodiment comprises the extracted address data, but not the proprietary data. The program instructions of this embodiment also comprise program instructions configured to direct transmission of the request to a geocoding service. The program instructions of this embodiment further comprise program instructions configured to direct receipt of geocoding information corresponding to the address data in response to the request. The program instructions of this embodiment additionally comprise program instructions configured to generate a geocoded data record comprising the geocoding information and at least a portion of the proprietary data. The program instructions of this embodiment also comprise program instructions configured to add the geocoded data record to a file formatted to be compatible with the mapping utility.

In another example embodiment, an apparatus for geocoding data for use by a mapping utility is provided. The apparatus of this embodiment comprises means for accessing a data record from a data set. The data record of this embodiment comprises proprietary data and address data associated with the proprietary data. The apparatus of this embodiment further comprises means for extracting the address data from the data record. The apparatus of this embodiment additionally comprises means for formatting a request for geocoding information corresponding to the address data. The request of this embodiment comprises the extracted address data, but not the proprietary data. The apparatus of this embodiment also comprises means for directing transmission of the request to a geocoding service. The apparatus of this embodiment further comprises means for receiving geocoding information corresponding to the address data in response to the request. The apparatus of this embodiment additionally comprises means for generating a geocoded data record comprising the geocoding information and at least a portion of the proprietary data. The apparatus of this embodiment also comprises means for adding the geocoded data record to a file formatted to be compatible with the mapping utility.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for geocoding data for use by a mapping utility according to an example embodiment of the present invention;

FIG. 2 illustrates an apparatus for geocoding data for use by a mapping utility according to an example embodiment of the present invention;

FIG. 3 illustrates an example data set having a plurality of data fields according to one embodiment of the invention;

FIG. 4 illustrates another example data set having a plurality of data fields according to an embodiment the invention;

FIG. 5 illustrates a further example data set having a plurality of data fields according to an embodiment the invention;

FIG. 6 illustrates a location indicator and a graphical display displaying data from a geocoded data record represented by the location indicator according to an example embodiment of the invention;

FIG. 7 illustrates another location indicator and a graphical display displaying data from a geocoded data record represented by the location indicator according to an example embodiment of the invention;

FIG. 8 illustrates a further location indicator and a graphical display displaying data from a geocoded data record represented by the location indicator according to an example embodiment of the invention;

FIG. 9 illustrates a series of map displays that may be generated by a mapping utility using a file comprising a plurality of geocoded data records generated in accordance with an example embodiment of the invention; and

FIG. 10 illustrates a flowchart according to an example method for geocoding data for use by a mapping utility according to an example embodiment of the invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

Although geocoding services configured to interpret address data and determine corresponding goecoding information (e.g., latitude and longitude coordinates corresponding to the address data) are available, conventional geocoding services and conventional methods of leveraging geocoding services include several drawbacks. A geocoding service may be accessed by a mapping utility when generating a map illustrating location(s) associated with data record(s) in order to geocode a data record(s) that does not include geocoding information. However, geocoding a data record may be relatively time consuming and thus geocoding a data record, let alone multiple data records may result in significant user wait time for a map to be rendered by the mapping utility and may impose a significant processing burden on a mapping utility called upon to render a map displaying non-geocoded data records.

Further, geocoding services are frequently maintained by third party providers, such as Google. Use of geocoding services by third party providers may be contingent upon an explicit or implied license giving the third party a right to store and/or use information supplied in a request for geocoding information. Accordingly, when a data record is submitted to a geocoding service in a request for geocoding information, such as by a mapping utility, the request may include proprietary data contained within the data record in addition to the address data needed to determine the geocoding information. Accordingly, confidentiality of the proprietary data may be compromised and the third party service provider may obtain a right to the proprietary data.

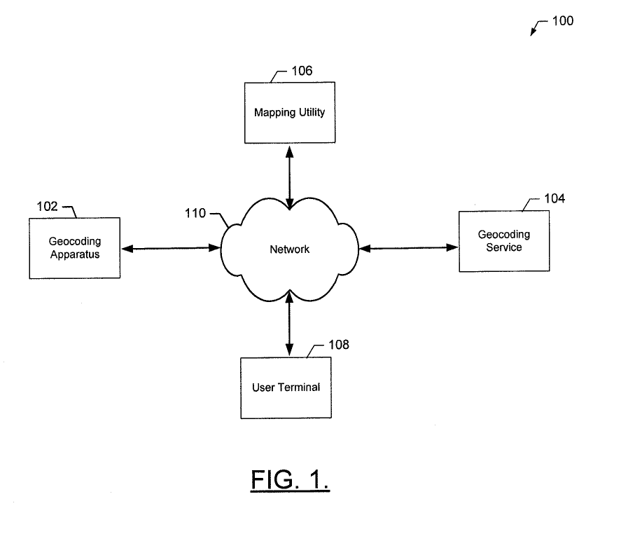

Embodiments of the invention therefore provide systems, methods, apparatuses, and computer program products that may provide benefit to computing devices and computing device users by geocoding data for use by a mapping utility. In this regard, FIG. 1 illustrates a system 100 for geocoding data for use by a mapping utility according to an example embodiment of the present invention. It will be appreciated that the system 100 as well as the illustrations of other figures are each provided as an example of one embodiment of the invention and should not be construed to narrow the scope or spirit of the invention in any way. In this regard, the scope of the invention encompasses many potential embodiments in addition to those illustrated and described herein. As such, while FIG. 1 illustrates one example of a configuration of a system for geocoding data for use by a mapping utility, numerous other configurations may also be used to implement embodiments of the present invention.

In at least some embodiments, the system 100 includes a geocoding apparatus 102, geocoding service 104, and mapping utility 106 configured to communicate over a network 110. The network 110 may comprise a wireless network (e.g., a cellular network, wireless local area network, wireless personal area network, wireless metropolitan area network, and/or the like), a wireline network, or some combination thereof, and in some embodiments comprises the internet.

The geocoding service 104 may be embodied as or on any computing device configured to receive address data over the network 110 and determine geocoding information, such as, for example, latitude and longitude coordinates, corresponding to the address data. In some embodiments, the geocoding service 104 comprises one or more servers. The mapping utility 106 may be embodied as or on any computing device configured to receive a compatible file comprising one or more geocoded data records and generate a map based on the received file including one or more location indicators marking locations of the one or more geocoded data records as specified by geocoding information in the received file. The mapping utility 106 may, for example, comprise one or more computing devices configured to implement a mapping utility, such as, for example, Google Earth, Google Maps, and/or the like.

Although illustrated in FIG. 1 as two distinct entities, in some embodiments the geocoding service 104 and mapping utility 106 are collocated on a single computing device or cluster of computing devices, such as one or more servers configured to provide functionality of both a geocoding service 104 and mapping utility 106. Further, although illustrated in FIG. 1 as a distinct entity, in some embodiments the mapping utility 106 comprises an application implemented locally on the geocoding apparatus 102 or on a user terminal 108.

In embodiments wherein the system 100 includes a user terminal 108, the user terminal 108 may comprise any computing device configured for use by a user to access geocoding services provided by the geocoding apparatus 102 over the network 110. In this regard, a user terminal 108 may be embodied as a desktop computer, laptop computer, mobile terminal, mobile computer, mobile phone, mobile communication device, audio/video player, television device, any combination thereof, and/or the like.

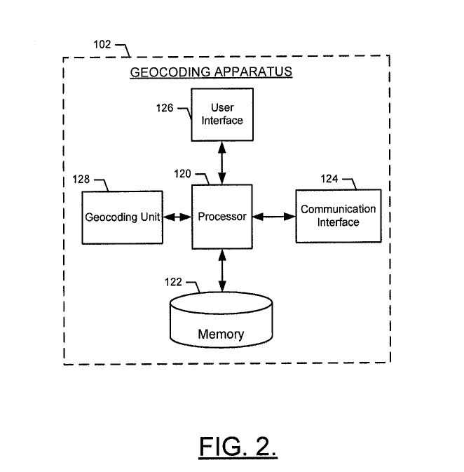

The geocoding apparatus 102 may be embodied as a server, desktop computer, laptop computer, mobile terminal, mobile computer, mobile phone, mobile communication device, audio/video player, television device, network node, multiple computing devices in communication with each other, any combination thereof, and/or the like. FIG. 2 illustrates one example embodiment of a geocoding apparatus 102 for geocoding data for use by a mapping utility according to an example embodiment of the present invention. As illustrated in FIG. 2, in an example embodiment, the geocoding apparatus 102 includes various means, such as a processor 120, memory 122, communication interface 124, user interface 126, and geocoding unit 128 for performing the various functions herein described. These means of the geocoding apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 122) that is executable by a suitably configured processing device (e.g., the processor 120), or some combination thereof.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof Accordingly, although illustrated in FIG. 2 as a single processor, in some embodiments the processor 120 comprises a plurality of processors. The plurality of processors may be embodied on a single computing device or may be distributed across a plurality of computing devices collectively configured to function as the geocoding apparatus 102. The plurality of processors may be in operative communication with each other and may be collectively configured to perform one or more functionalities of the geocoding apparatus 102 as described herein. In an example embodiment, the processor 120 is configured to execute instructions stored in the memory 122 or otherwise accessible to the processor 120. These instructions, when executed by the processor 120, may cause the geocoding apparatus 102 to perform one or more of the functionalities of the geocoding apparatus 102 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may comprise, for example, volatile, non-volatile memory, or some combination thereof. Although illustrated in FIG. 2 as a single memory, the memory 122 may comprise a plurality of memories. The plurality of memories may be embodied on a single computing device or distributed across a plurality of computing devices. In various embodiments, the memory 122 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the geocoding apparatus 102 to carry out various functions in accordance with example embodiments of the present invention. For example, in at least some embodiments, the memory 122 is configured to buffer input data for processing by the processor 120. Additionally or alternatively, in at least some embodiments, the memory 122 is configured to store program instructions for execution by the processor 120. The memory 122 may store information in the form of static and/or dynamic information. This stored information may be stored and/or used by the geocoding unit 128 during the course of performing its functionalities.

The communication interface 124 may be embodied as any device or means embodied in circuitry, hardware, a computer program product comprising computer readable program instructions stored on a computer readable medium (e.g., the memory 122) and executed by a processing device (e.g., the processor 120), or a combination thereof that is configured to receive and/or transmit data from/to another device, such as, for example, a geocoding service 104, mapping utility 106, user terminal 108, and/or the like. In at least one embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver, network interface card, and/or supporting hardware or software for enabling communications with another computing device. The communication interface 124 may be configured to receive and/or transmit data using any protocol that may be used for communications between computing devices. The communication interface 124 may additionally be in communication with the memory 122, user interface 126, and/or geocoding unit 128, such as via a bus.

The user interface 126 may be in communication with the processor 120 to receive an indication of a user input and/or to provide an audible, visual, mechanical, or other output to a user. As such, the user interface 126 may include, for example, a keyboard, a mouse, a joystick, a display, a touch screen display, a microphone, a speaker, and/or other input/output mechanisms. In embodiments wherein the geocoding apparatus 102 is embodied as a server, aspects of the user interface 126 may be reduced or the user interface 126 may even be eliminated. Alternatively, such as in embodiments wherein the geocoding apparatus 102 is embodied as a server, at least some aspects of the user interface 126 may be embodied on an apparatus used by a user that is in communication with the geocoding apparatus 102, such as for example, the user terminal 108. The user interface 126 may be in communication with the memory 122, communication interface 124, and/or geocoding unit 128, such as via a bus.

The geocoding unit 128 may be embodied as various means, such as circuitry, hardware, a computer program product comprising computer readable program instructions stored on a computer readable medium (e.g., the memory 122) and executed by a processing device (e.g., the processor 120), or some combination thereof and, in one embodiment, is embodied as or otherwise controlled by the processor 120. In embodiments wherein the geocoding unit 128 is embodied separately from the processor 120, the geocoding unit 128 may be in communication with the processor 120. The geocoding unit 128 may further be in communication with one or more of the memory 122, communication interface 124, or user interface 126, such as via a bus.

It will be appreciated that when the geocoding unit 128 is described herein to access a data set or other data from the memory 122, accessing data from the memory 122 is provided merely for purposes of example and the geocoding unit 128 may be configured to access data from the memory 122 and/or from a user terminal 108 over the network 108. In embodiments wherein the geocoding unit 128 is configured to access data, such as, for example, a data set, from a user terminal 108, the geocoding unit 128 may be configured to retrieve the data from the user terminal 108 and/or may be configured to receive data sent to the geocoding apparatus 102 by the user terminal 108.

In embodiments, wherein a user terminal 108 is used to access geocoding services provided by the geocoding apparatus 102, elements of the geocoding apparatus 102 that were described with respect to FIG. 2 and functionality attributed thereto may be distributed between the geocoding apparatus 102 and user terminal 108. For example, the geocoding unit 128 may be distributed between the geocoding apparatus 102 and user terminal 108, such that functionality attributed to the geocoding unit 128 may be performed by the geocoding apparatus 102 and/or by the user terminal 108. Additionally or alternatively, where the geocoding unit 128 is said to cause a graphical user interface, data, and/or the like to be displayed, it will be appreciated that the geocoding unit 128 may be configured to cause the graphical user interface, data, and/or the like to be displayed on a display coupled to the geocoding apparatus 102 and/or may be configured to direct transmission of the data to be displayed via the communication interface 124 to a user terminal 108 such that the graphical user interface, data, and/or the like may be displayed on a display coupled to the user terminal 108. Similarly, where receipt of a user input is described, it will be appreciated that the user may be providing the selection or input via the user interface 126 and/or may be interacting with a user terminal 108 such that the input and/or selection is transmitted from the user terminal 108 to the geocoding apparatus 102, where it may be received by the communication interface 124 and/or geocoding unit 128. Further, program instructions, data, and/or the like said to be stored in the memory 122 may be stored at the geocoding apparatus 102 and/or may be stored on a user terminal 108.

In embodiments wherein the system 100 includes a user terminal 108, the geocoding apparatus 102 may be embodied as a middle server. In this regard, the user terminal 108 may be configured to access the geocoding apparatus 102 and the geocoding apparatus 102 may be configured to serve as an intermediate host to access the geocoding service 104 and/or mapping utility 106 in a manner that is transparent to the user terminal 108.

In some embodiments, the geocoding unit 128 is configured to receive or otherwise access a data set, such as from the memory 122 and/or user terminal 108. The geocoding unit 128 may be configured to access a data set in response to a user input. The user input may be received via a graphical user interface, a command line interface (e.g., Microsoft Disk Operating System command line interface, Linux shell, or the like), and/or the like. In this regard, a user may request the geocoding unit 128 to geocode a data set.

The data set may comprise a spreadsheet, one or more worksheets of a spreadsheet, a database, a data table, data stream (e.g., a data stream transmitted to the geocoding apparatus 102 by the user terminal 108), an output (e.g., an extract in the form of a data table, spreadsheet or the like) generated by a customer relationship management (CRM) application (e.g., a Siebel application, PeopleSoft application, or the like), and/or the like comprising one or more data records. The data set may comprise a plurality of data fields. Data that comprises a data record may be contained within the data fields. The data fields may serve to categorize the data contained within them. In this regard, data fields for a data set may be specified in accordance with a database format, in the first row of a data table or spreadsheet, or the like.

A data record may comprise address data and proprietary data. The address data and/or proprietary data may be contained within one or more data fields. The address data may comprise, for example, street address, city, state, zip code, and/or other address data. The proprietary data may comprise any non-address data and may, but does not necessarily, comprise data that is confidential to a business, person, or other entity that generated the data record and/or data set in which the data record is contained. By way of example and not by way of limitation, the proprietary data may comprise, for example, an account identifier, customer identifier, customer classification, sales data, and/or the like.

In embodiments wherein an accessed data set comprises data fields, the data fields may be categorized as default data fields or optional data fields. Default data fields may comprise those data fields which the geocoding unit 128 is configured to recognize and automatically include in a generated geocoded data record whenever present in an accessed data set and/or in a data record accessed from the data set. Optional data fields may comprise data fields that the geocoding unit 128 is not configured to automatically include in a generated geocoded data record even when present in an accessed data set and/or in a data record accessed from the data set. One or more default data fields may comprise mandatory data fields. In this regard, mandatory data fields may comprise data fields that must be present in a data set in order for the data set to be properly formatted for accessing and processing by the geocoding unit 128.

In some embodiments, the geocoding unit 128 may be configured to recognize a plurality of name variations for a default data field. For example, the geocoding unit 128 may be configured to recognize the names “Account,” “Account Name,” “Account ID,” and/or the like as the data field “Account.” As another example, the geocoding unit 128 may be configured to recognize the names “Primary Address Line 1,” “Address,” “Address Line 1,” “Primary Address,” and/or the like as the data field “Address.” As a further example, the geocoding unit 128 may be configured to recognize the names “City,” “Primary City,” “Main Facility City,” and/or the like as the data field “City.” As an additional example, the geocoding unit 128 may be configured to recognize the names “State,” “Primary State,” “Main Facility State,” and/or the like as the data field “State.”

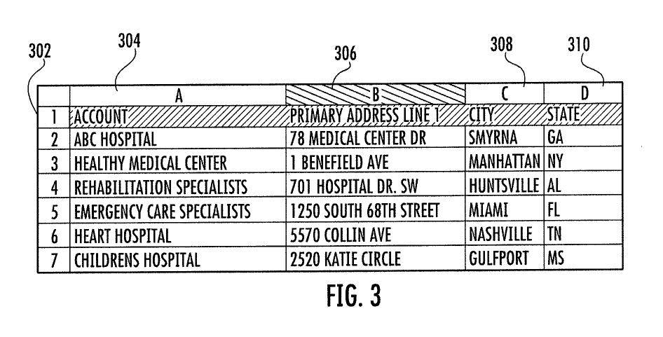

Referring now to FIG. 3, FIG. 3 illustrates an example data set having a plurality of data fields according to one embodiment of the invention. In this regard, FIG. 3 illustrates a data set formatted as a spreadsheet. The data fields are set forth in the first row 302 of the spreadsheet and comprise “Account” data field 304, “Primary Address Line 1” data field 306, “City” data field 308, and “State” data field 310. In the embodiment illustrated in FIG. 3, for a respective data field, the cells that comprise the column in which the data field is located may contain data of respective data records associated with that data field. The data records of the data set illustrated in FIG. 3 are set forth in the rows below the first row 302 with portions of the data records being contained in respective appropriate columns defined by the data fields 306-310. Accordingly, for a particular data record included in a data set formatted as a spreadsheet, such as that illustrated in FIG. 3, the geocoding unit 128 may be configured to access and/or extract data contained within a particular data field of the data record by extracting data from the cell of the data record that is in the column of the particular data field for which data is to be accessed and/or extracted.

In FIG. 3, data contained within the data fields 306-310 (e.g., the cells within the columns defined by data fields 306-310) comprises address data. Data contained within the data field 304 (e.g., the cells within the column defined by data field 304) comprises proprietary data. In the example illustrated in FIG. 3. Each of the data fields 304-310 may comprise mandatory data fields for a data set specifying data records for sales accounts.

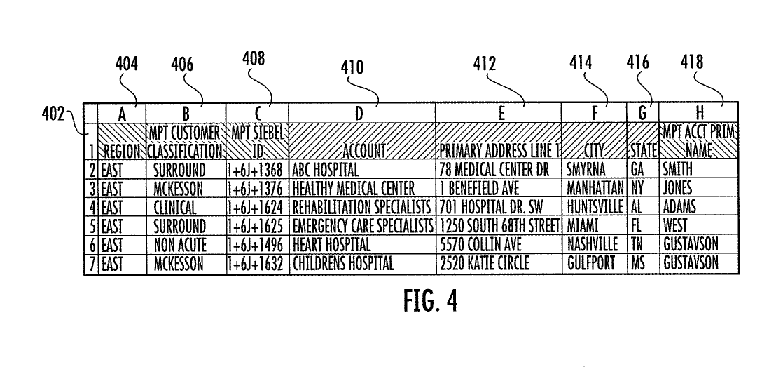

FIG. 4 illustrates another example data set having a plurality of data fields according to an embodiment of the invention. In this regard, FIG. 4 illustrates a data set comprising data fields for proprietary data in addition to those illustrated in the data set of FIG. 3. These additional data fields for proprietary data may comprise default data fields. Similarly to FIG. 3, the data fields of the data set of FIG. 4 are set forth in the first row 402 of the spreadsheet and comprise “Region” data field 404, “MPT Customer Classification” data field 406, “MPT Siebel ID” data field 408, “Account” data field 410, “Primary Address Line 1” data field 412, “City” data field 414, “State” data field 416, and “MPT Acct Prim Name” data field 418. The data fields 404-408 and 418 may comprise proprietary data and the data fields 410-416 may comprise address data.

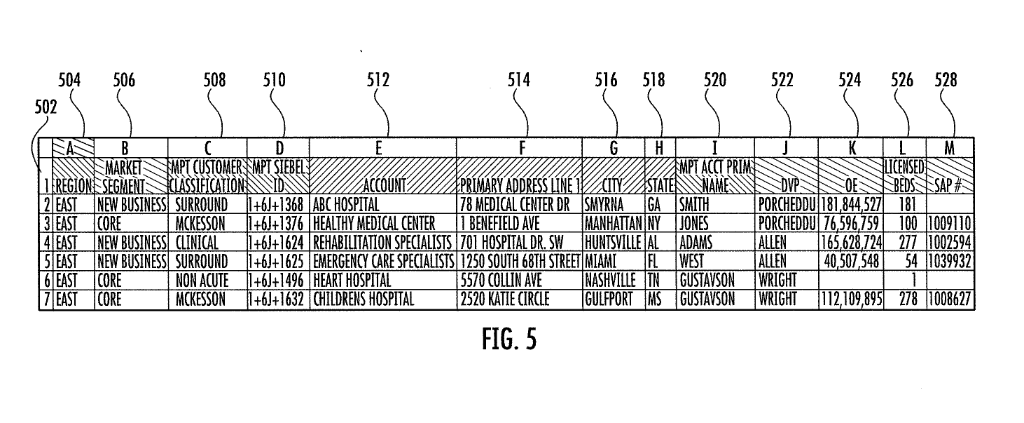

FIG. 5 illustrates a further example data set having a plurality of data fields according to an embodiment the invention. In this regard, FIG. 5 illustrates a data set comprising data fields for proprietary data in addition to those illustrated in the data set of FIG. 4. These additional data fields for proprietary data may comprise optional data fields. Similarly to FIGS. 3 and 4, the data fields of the data set of FIG. 5 are set forth in the first row 502 of the spreadsheet and comprise “Region” data field 504, “Market Segment” data field 506, “MPT Customer Classification” data field 508, “MPT Siebel ID” data field 510, “Account” data field 512, “Primary Address Line 1” data field 514, “City” data field 516, “State” data field 518, “MPT Acct Prim Name” data field 520, “DVP” data field 522, “OE” data field 524, “Licensed Beds” data field 526, and “SAP #” data field 528. The data fields 504-510 and 520-528 may comprise proprietary data and the data fields 512-519 may comprise address data. The data fields 506 and 522-528 may comprise optional data fields.

It will be appreciated that the names of data fields illustrated in and described above with respect to FIGS. 3-5 are provided for purposes of example and not by way of limitation. Accordingly a data set may comprise data fields having alternative names as well as data fields in addition to or in lieu of the data fields illustrated in FIGS. 3-5. Further, the type of data included in the data records of FIGS. 3-5 is provided merely for purposes of example and not by way of limitation.

The geocoding unit 128 is configured in some embodiments to access a data record from a data set and extract address data from the data record. The geocoding unit 128 may be further configured to format a request to the geocoding service 104 for geocoding information corresponding to the address data. The formatted request may comprise the extracted address data, but not the proprietary data of the data record. Accordingly, the geocoding unit 128 may be configured to obtain geocoding information for a data record while preserving the integrity of proprietary data of the data record.

In some embodiments, the geocoding unit 128 is configured to batch geocode a plurality of data records. In this regard, the geocoding unit 128 may be configured to access a plurality of data records of a data set and extract address data from the plurality of data records. The geocoding unit 128 may be configured to format a request to the geocoding service 104 for geocoding information for each of the plurality of data records.

The geocoding unit 128 may be configured to determine whether a data record of a data set already includes geocoding information prior to extracting address data from the data record and formatting a request for geocoding information corresponding to the address data for the data record. In this regard, the geocoding unit 128 may be configured to extract the address data and request the geocoding service 104 to provide geocoding information corresponding to the address data when the geocoding unit 128 determines that the data record does not already include geocoding information.

In some embodiments, the geocoding unit 128 is additionally configured to direct transmission of a formatted request for geocoding information to the geocoding service 104. The geocoding service 104 may be configured to determine geocoding information corresponding to the address data in the request and send a response comprising the determined geocoding information to the geocoding apparatus 102. The geocoding unit 128 may be configured to receive the response sent by the geocoding service 104. The geocoding unit 128 may be further configured to generate a geocoded data record comprising geocoding information received in the response that corresponds to address data extracted from a data record and at least a portion of proprietary data of the data record.

In some embodiments, the geocoding unit 128 is configured to generate a geocoded data record comprising all of the proprietary data of a data record corresponding to the generated geocoded data record. In other embodiments, the geocoding unit 128 is configured to generate a geocoded data record comprising only proprietary data contained within default data fields of the data record corresponding to the geocoded data record unless otherwise specified by a specification parameter. In this regard, in some embodiments, when a user requests geocoding of a data set, the user may specify one or more optional data fields of the data set to include in geocoded data record(s) generated by the geocoding unit 128 by way of a specification parameter(s). Such specification by the user may be made in any number of ways depending on the interface provided to allow the user to select a data set for geocoding by the geocoding unit 128. For example, the geocoding unit 128 may be configured to direct display of a graphical user interface listing optional data fields of a data set and allow a user to select one or more of the listed optional data fields for inclusion in a generated geocoded data record by way of radio buttons, check boxes, and/or the like.

In another example, a user may specify an optional data field for inclusion in a generated geocoded data record by way of a specification parameter included in a command line input. In this regard, each optional data field that the user wants to be included may be specified in a separate command line parameter. For example, in embodiments wherein the geocoding unit 128 is configured to receive a command for geocoding a data set via a Microsoft Disk Operating System (MS-DOS) command line interface, a user may command geocoding of a data set stored in the spreadsheet MCKExcelExample.xls through the command:

mckxls—input MCKExcelExample.xls

If the user wants the geocoding unit 128 to include the optional data fields “Market Segment” and “Licensed Beds” in the generated geocoded data record(s), the user may enter the command:

mckxls—input MCKExcelExample.xls—c1 “Market Segment”—c2 “Licensed Beds”

In some embodiments, the user may be able to additionally or alternatively specify one or more data fields for the geocoding unit 128 to not include in a generated geocoded data record. Such a negative specification may be made through a specification parameter similar to those described above. The geocoding unit 128 may also be configured to include at least a portion of address data from the data record corresponding to the generated geocoded data record in the data record.

The geocoding unit 128 may be further configured to add a generated geocoded data record(s) to a file formatted to be compatible with the mapping utility 106. In some embodiments, such as embodiments wherein the mapping utility 106 comprises Google Earth or Google Maps, the geocoding unit 128 may be configured to format the file to which a geocoded data record is added as a .xml file compatible for use by the mapping utility 106. In this regard, a compatible file is one that the mapping utility 106 may open, interpret, execute, and/or the like. Accordingly, by embodiments of the invention, a file comprising one or more geocoded data records generated by the geocoding unit 128 may be accessed, opened, executed, and/or the like by the mapping utility 106, such as in response to a user command. The mapping utility 106 may utilize the file to render a map display specified based on the file contents.

The geocoding unit 128 may be configured to format the file such that when the file is formatted to specify display of a location indicator representing a geocoded data record added to the file at a location on a map display specified by the geocoding information when the mapping utility 106 generates a map display using the file. In some embodiments, a location indicator may comprise a callout box or other graphic including text of data contained within one or more data fields of the geocoded data record which is represented by the location indicator. In this regard, the text may comprise data contained within one or more proprietary data fields of the geocoded data record which is represented by the location indicator. The text may additionally or alternatively comprise data contained within one or more address data fields of the geocoded data record which is represented by the location indicator.

In other embodiments, a location indicator may comprise a graphic, icon, symbol, or the like. Such a location indicator may be selectable such that a user may select a location indicator from a map display. The file generated by the geocoding unit 128 may specify that the mapping utility 106 direct display of a graphical display, such as, for example, a pop up display, in response to selection of a location indicator. A graphical display displayed in response to selection of a location indicator may comprise at least a portion of the proprietary data contained within data fields of the geocoded data record that is represented by the selected location indicator such that a user may view data contained within a geocoded data record associated with a location indicator. The graphical display may additionally display address data contained within data fields of the geocoded data record that is represented by the selected location indicator.

In some embodiments, a user may be able to specify appearance of a location indicator by way of a specification parameter provided as input when the user selects a data set for geocoding by the geocoding unit. The user may input the specification parameter by any of the means discussed above with respect to specification parameters specifying data fields for inclusion in a generated geocoded data record. For example, in embodiments wherein the geocoding unit 128 is configured to receive a command for geocoding a data set via an MS-DOS command line interface, a user may command geocoding of a data set stored in the spreadsheet MCKExcelExample.xls and specify use of red location indicators through the command:

mckxls—input MCKExcelExample.xls—color red

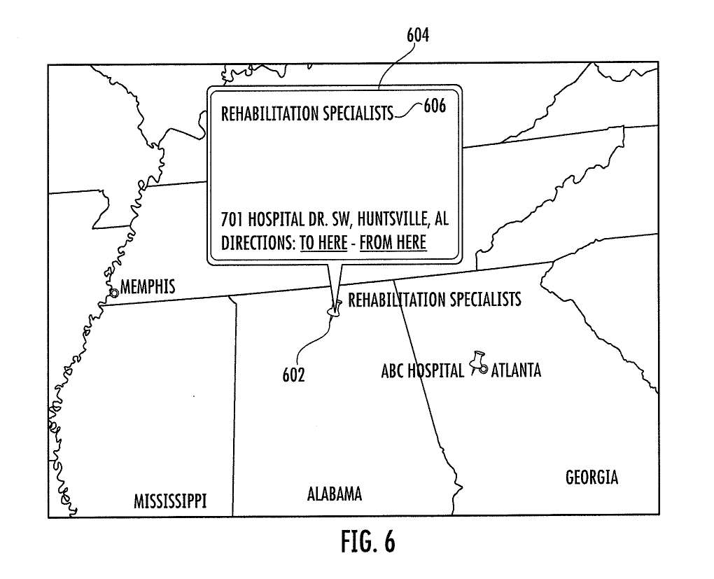

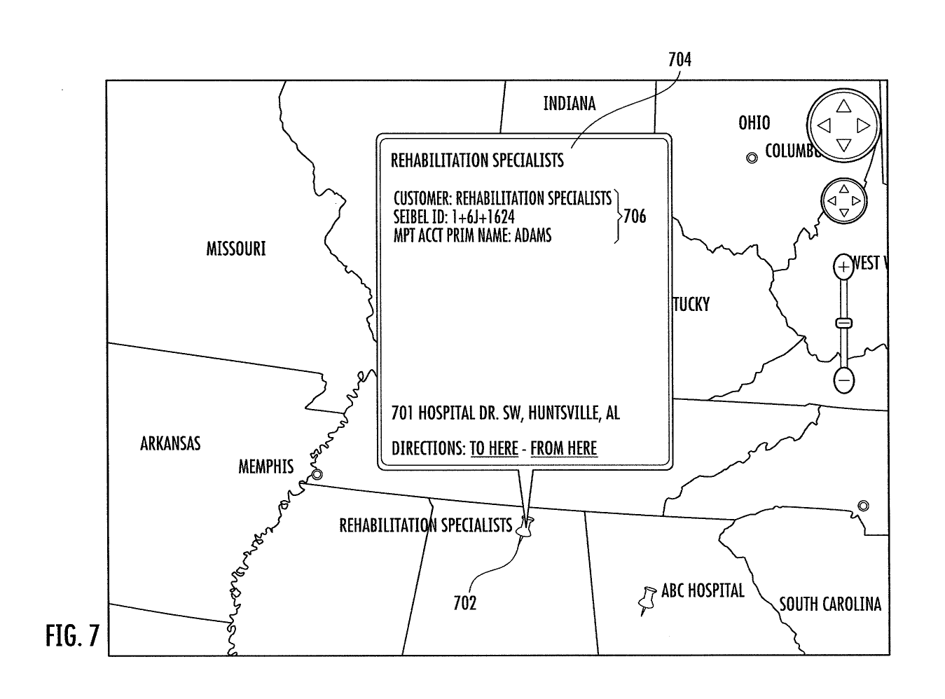

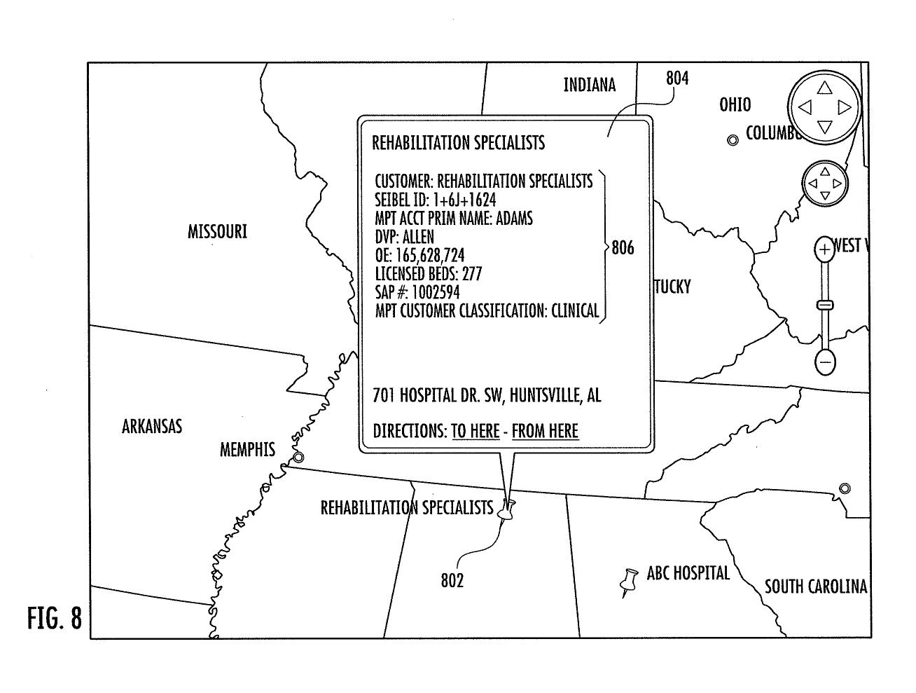

FIG. 6 illustrates a location indicator and a graphical display displaying data from a geocoded data record represented by the location indicator according to an example embodiment of the invention. In this regard, FIG. 6 illustrates a location indicator 602 at a location on a map display corresponding to the geocoding information of the geocoded data record represented by the location indicator 602. FIG. 6 further illustrates the graphical display 604, which may, for example, be displayed in response to user selection of the location indicator 602. The only proprietary data included in the graphical display 604 is the name 606 (“Rehabilitation Specialists”). In this regard, the name 606 may comprise, for example, an identifier of an account or other entity associated with the geocoded data record represented by the location indicator 602. The location indicator 602 and graphical display 604 may represent a geocoded data record generated from a data record comprising only the data fields illustrated in the example data set of FIG. 3.

FIG. 7 illustrates another location indicator and a graphical display displaying data from a geocoded data record represented by the location indicator according to an example embodiment of the invention. In this regard, FIG. 7 illustrates a location indicator 702 at a location on a map display corresponding to the geocoding information of the geocoded data record represented by the location indicator 702. FIG. 7 further illustrates the graphical display 704, which may, for example, be displayed in response to user selection of the location indicator 702. In addition to the name as displayed in the graphical display 604, the graphical display 704 further comprises the proprietary data 706 including “Customer” data, “Siebel ID” data, and “MPT Acct Prim Name” data. Accordingly, the data record based upon which the geocoding unit 128 generated the geocoded data record represented by the location indicator may have comprised “Customer,” “Siebel ID,” and “MPT Acct Prim Name” data fields, which the geocoding unit 128 included when generating the geocoded data record.

FIG. 8 illustrates a further location indicator and a graphical display displaying data from a geocoded data record represented by the location indicator according to an example embodiment of the invention. In this regard, FIG. 8 illustrates a location indicator 802 at a location on a map display corresponding to the geocoding information of the geocoded data record represented by the location indicator 802. FIG. 8 further illustrates the graphical display 804, which may, for example, be displayed in response to user selection of the location indicator 802. In addition to the name as displayed in the graphical display 604, the graphical display 804 further comprises the proprietary data 806 including “Customer” data, “Siebel ID” data, “MPT Acct Prim Name” data, “DVP” data, “OE” data, “Licensed Beds” data, “SAP #” data, and “MPT Customer Classification” data. Accordingly, the data record based upon which the geocoding unit 128 generated the geocoded data record represented by the location indicator may have comprised “Customer,” “Siebel ID,” “MPT Acct Prim Name,” “DVP,” “OE,” “Licensed Beds,” “SAP #,” and “MPT Customer Classification” data fields, which the geocoding unit 128 included when generating the geocoded data record. At least some of these data fields may comprise optional data fields specified for inclusion in the geocoded data record through one or more specification parameters as previously described.

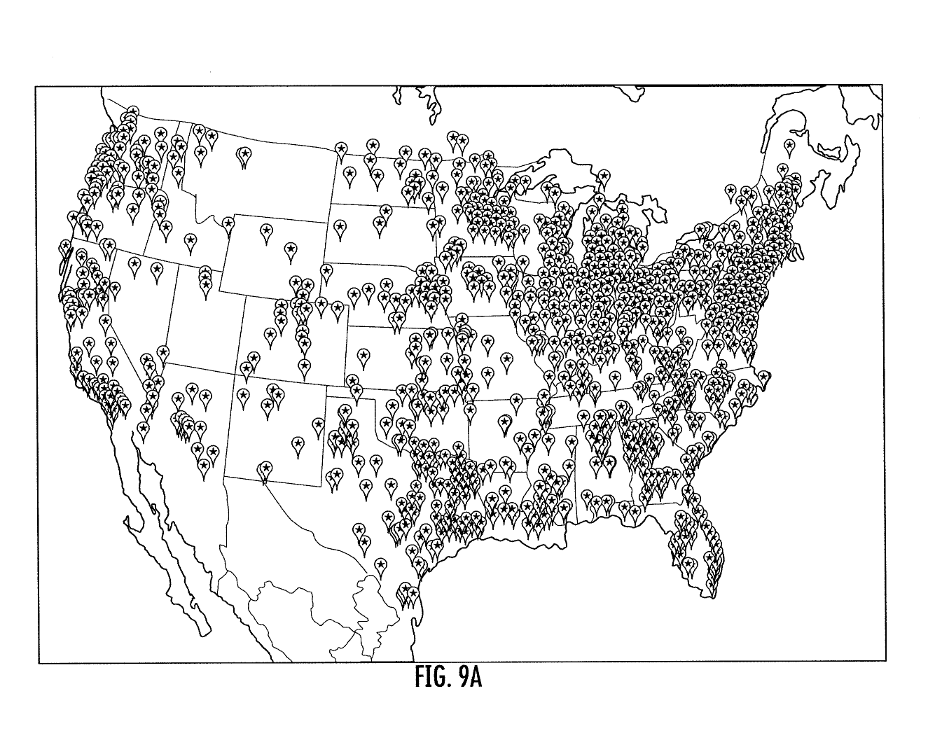

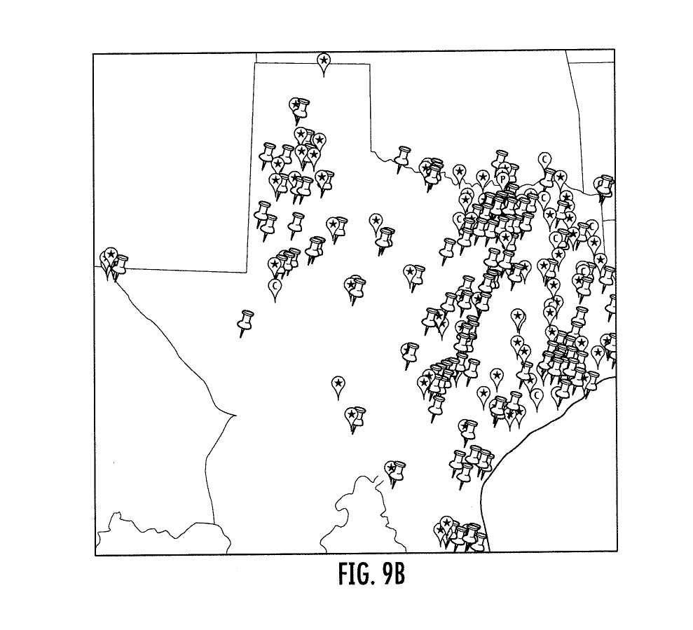

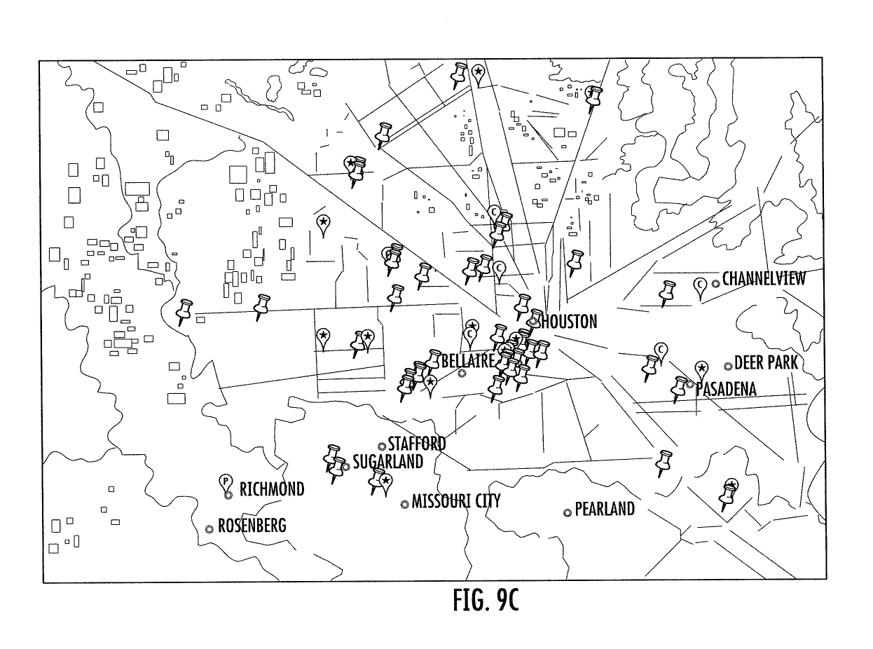

It will be appreciated that embodiments of the invention may be utilized to generate geocoded data records that may viewed as points on a map display. Such a display may be leveraged for virtually any purpose depending on the type of data which is geocoded and the individual user. One example usage is to view market penetration and/or market share with respect to sales data. In this regard, FIG. 9 illustrates a series of map displays that may be generated by a mapping utility 106 using a file comprising a plurality of geocoded data records generated by the geocoding unit 128 in accordance with an example embodiment of the invention.

FIG. 9a shows a map display illustrating a plurality of location indicators distributed through the continental United States. The location indicators may comprise a plurality of different types and/or colors of location indicators. Each type and/or color of location indicator may comprise to location indicators representing geocoded data records of a unique data set. In this regard, the geocoding unit 128 may be configured in some embodiments of the invention to generate geocoded data records corresponding to data records of a plurality of data sets and/or a plurality of sections of a data set (e.g., worksheets of a spreadsheet) and add the generated geocoded data records to a single file compatible with the mapping utility 106. A unique location indicator may be specified for representation of the geocoded data records of each respective data set and/or section of a data set represented by the geocoded records of the file. Such embodiments may, for example, allow for cross-comparison between data sets. In this regard, a user may, for example, compare market penetration of two competing or comparable products or services.

A user may use features provided by the mapping utility 106 to pan and zoom to focus on an area of the map display of FIG. 9a. Accordingly, a user may, for example, zoom into a specific area to see a more detailed view of geocoded data records having a location within an area of interest to the user. In this regard, FIGS. 9b and 9c illustrate a zoomed display of Texas (FIG. 9b) and Houston (FIG. 9c) that may be viewed by zooming in on the map display of FIG. 9a to view greater detail at a more localized level.

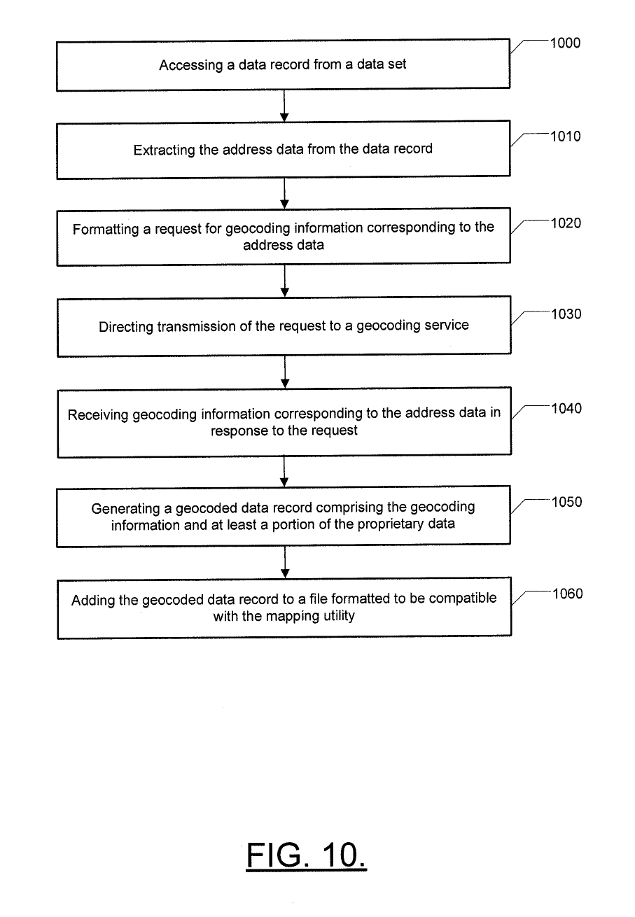

FIG. 10 illustrates a flowchart according to an example method for geocoding data for use by a mapping utility according to an example embodiment of the invention. Operations illustrated in FIG. 10 may, for example, be performed by and/or with the assistance of the geocoding unit 128. The method may include accessing a data record from a data set, at operation 1000. The data record may comprise proprietary data and address data associated with the proprietary data. Operation 1010 may comprise extracting the address data from the data record. The method may further include formatting a request for geocoding information corresponding to the address data, at operation 1020. The request may comprise the extracted address data, but not the proprietary data. Operation 1030 may comprise directing transmission of the request to a geocoding service, such as, for example, the geocoding service 104. Operation 1040 may comprise receiving geocoding information corresponding to the address data in response to the request. The method may additionally include generating a geocoded data record comprising the geocoding information and at least a portion of the proprietary data, at operation 1050. Operation 1060 may comprise adding the geocoded data record to a file formatted to be compatible with a mapping utility, such as, for example, the mapping utility 106.

FIG. 10 is a flowchart of a system, method, and computer program product according to example embodiments of the invention. It will be understood that each block or step of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a server, desktop computer, laptop computer, mobile computer, or other computing device (e.g., the geocoding apparatus 102, user terminal 108, combination thereof, and/or the like) and executed by a processor (e.g., the processor 120) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s) or step(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s) or step(s). The computer program instructions of one or more computer program products may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions and combinations of steps for performing the specified functions. It will also be understood that one or more blocks or steps of the flowchart, and combinations of blocks or steps in the flowchart, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

As such, then, some embodiments of the invention provide several advantages to computing devices and computing device users. Embodiments of the invention provide for pre-geocoding of data. In this regard, embodiments of the invention provide for the generation of a file formatted for compatibility with a mapping utility that comprises one or more geocoded data records. Embodiments of the invention may provide for generation of such a file in advance of a request to render data records on a map using a mapping utility such that the data records are pre-geocoded so that data records do not have to be geocoded by the mapping utility during rendering of the map. As geocoding a data record may be a relatively time consuming process, pre-geocoding data records in accordance with embodiments of the invention may result in less user wait time for a map to be rendered and reduce the processing burden on mapping utilities. Embodiments of the invention additionally protect the confidentiality of proprietary data that may be included in a data record to be geocoded. In this regard, embodiments of the invention extract only the address data needed to obtain geocoding information from a data record and send the extracted address data to a geocoding service in a request for geocoding information corresponding to the extracted address data rather than sending the entire data record to the geocoding service. Accordingly, the proprietary information is not exposed to third parties through provision to the geocoding service.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for geocoding data for use by a mapping utility, the method comprising:
accessing a data record from a data set, the data record comprising proprietary data and address data associated with the proprietary data;
extracting the address data from the data record;
formatting a request for geocoding information corresponding to the address data, the request comprising the extracted address data, but not the proprietary data;
directing transmission of the request to a geocoding service;
receiving geocoding information corresponding to the address data in response to the request;
generating, by a geocoding unit, a geocoded data record comprising the geocoding information and at least a portion of the proprietary data; and
adding the geocoded data record to a file formatted to be compatible with the mapping utility.

2. The method of claim 1, wherein the data set comprises a plurality of data records, and wherein:
accessing a data record comprises accessing two or more of the plurality of data records;
extracting comprises extracting address data from each of the two or more of the plurality of data records;
formatting comprises formatting a request for geocoding information corresponding to the address data of each of the two or more of the plurality of data records;
receiving comprises receiving geocoding information corresponding to the address data of each of the two or more of the plurality of data records;
generating a geocoded data record comprises generating a geocoded data record corresponding to each of the two or more of the plurality of data records; and
adding the geocoded data record comprises adding each of the two or more of the plurality of data records to the file.

3. The method of claim 1, further comprising determining whether the accessed data record includes geocoding information; and wherein extracting the address data from the data record comprises extracting the address data from the data record when it is determined that the accessed data record does not include geocoding information.

4. The method of claim 1, wherein the data record comprises a plurality of data fields, the proprietary data being contained within the data fields, and wherein the plurality of data fields comprise one or more default data fields and one or more optional data fields, the method further comprising:
determining at least one optional data field specified for inclusion in the geocoded data record by a received specification parameter; and
wherein generating the geocoded data record comprises generating a geocoded data record comprising proprietary data contained within the one or more default data fields and proprietary data contained within the at least one specified optional data field.

5. The method of claim 1, wherein the file is formatted to specify display of a location indicator representing the geocoded data record at a location on a map display specified by the geocoding information when the file is used by the mapping utility to generate the map display.

6. The method of claim 5, further comprising determining one or more of a color or icon specified by a received specification parameter, and wherein adding the geocoded data record to the file comprises adding the geocoded data record to the file along with an indication specifying that the location indicator be rendered based on the one or more of the color or icon specified by the received specification parameter when the file is used by the mapping utility to generate the map display.

7. The method of claim 5, wherein the file is formatted to specify display of a selectable location indicator, and wherein the file is further formatted to specify display of a graphical display comprising the at least a portion of the proprietary data that comprises the geocoded data record in response to selection of the location indicator.

8. The method of claim 1, wherein:
accessing the data record from the data set comprises accessing the data record from a data set provided by a first remote computing device; and
directing transmission of the request to a geocoding service comprises directing transmission of the request to a second remote computing device.

9. The method of claim 1, wherein the data set comprises one of a spreadsheet, database, data stream, or an output of a customer relationship management application.

10. The method of claim 1, wherein the proprietary data comprises one or more of an account identifier, customer identifier, customer classification, or sales data.

11. An apparatus for geocoding data for use by a mapping utility, the apparatus comprising a processor configured to cause the apparatus to at least:
access a data record from a data set, the data record comprising proprietary data and address data associated with the proprietary data;
extract the address data from the data record;
format a request for geocoding information corresponding to the address data, the request comprising the extracted address data, but not the proprietary data;
direct transmission of the request to a geocoding service;
receive geocoding information corresponding to the address data in response to the request;
generate a geocoded data record comprising the geocoding information and at least a portion of the proprietary data; and
add the geocoded data record to a file formatted to be compatible with the mapping utility.

12. The apparatus of claim 11, wherein the processor is configured to cause the apparatus to:
access a data record by accessing two or more of the plurality of data records;
extract the address data by extracting address data from each of the two or more of the plurality of data records;
format the request by formatting a request for geocoding information corresponding to the address data of each of the two or more of the plurality of data records;
receive the geocoding information by receiving geocoding information corresponding to the address data of each of the two or more of the plurality of data records;
generate a geocoded data record by generating a geocoded data record corresponding to each of the two or more of the plurality of data records; and
add the geocoded data record by adding each of the two or more of the plurality of data records to the file.

13. The apparatus of claim 11, wherein the processor is further configured to cause the apparatus to determine whether the accessed data record includes geocoding information; and wherein the processor is configured to cause the apparatus to extract the address data from the data record when it is determined that the accessed data record does not include geocoding information.

14. The apparatus of claim 11, wherein the data record comprises a plurality of data fields, the proprietary data being contained within the data fields, and wherein the plurality of data fields comprise one or more default data fields and one or more optional data fields, and wherein the processor is further configured to cause the apparatus to:
determine at least one optional data field specified for inclusion in the geocoded data record by a received specification parameter; and
wherein the processor is configured to cause the apparatus to generate the geocoded data record by generating a geocoded data record comprising proprietary data contained within the one or more default data fields and proprietary data contained within the at least one specified optional data field.

15. The apparatus of claim 11, wherein the processor is configured to cause the apparatus to:
access the data record from the data set by accessing the data record from a data set provided by a first remote apparatus; and
direct transmission of the request to a geocoding service by directing transmission of the request to a second remote apparatus.

16. The apparatus of claim 11, wherein the data set comprises one of a spreadsheet, database, data stream, or an output of a customer relationship management application.

17. The apparatus of claim 11, wherein the proprietary data comprises one or more of an account identifier, customer identifier, customer classification, or sales data.

18. The apparatus of claim 11, further comprising at least one memory storing instructions that when executed by the processor cause the apparatus to at least:
access a data record from a data set, the data record comprising proprietary data and address data associated with the proprietary data;
extract the address data from the data record;
format a request for geocoding information corresponding to the address data, the request comprising the extracted address data, but not the proprietary data;
direct transmission of the request to a geocoding service;
receive geocoding information corresponding to the address data in response to the request;
generate a geocoded data record comprising the geocoding information and at least a portion of the proprietary data; and
add the geocoded data record to a file formatted to be compatible with the mapping utility.

19. A computer program product comprising at least one computer-readable storage medium having computer-readable program instructions stored therein, the computer-readable program instructions comprising:
program instructions configured to access a data record from a data set, the data record comprising proprietary data and address data associated with the proprietary data;
program instructions configured to extract the address data from the data record;
program instructions configured to format a request for geocoding information corresponding to the address data, the request comprising the extracted address data, but not the proprietary data;
program instructions configured to direct transmission of the request to a geocoding service;
program instructions configured to direct receipt of geocoding information corresponding to the address data in response to the request;
program instructions configured to generate a geocoded data record comprising the geocoding information and at least a portion of the proprietary data; and
program instructions configured to add the geocoded data record to a file formatted to be compatible with the mapping utility.

20. The computer program product of claim 19, wherein the data record comprises a plurality of data fields, the proprietary data being contained within the data fields, and wherein the plurality of data fields comprise one or more default data fields and one or more optional data fields, and wherein the computer-readable program instructions further comprise:
program instructions configured to determine at least one optional data field specified for inclusion in the geocoded data record by a received specification parameter; and
wherein the program instructions configured to generate the geocoded data record comprise program instructions configured to generate a geocoded data record comprising proprietary data contained within the one or more default data fields and proprietary data contained within the at least one specified optional data field.
